(19) United States
(12) Patent Application Publication
(10) Pub. No.: US 2003/0124357 A1
(43) Pub. Date: Jul. 3, 2003

(54) Graft copolymers based on polyurethane, the production thereof and their use

(76) Inventors: Hartmut Kagerer, Lunen (DE); Hans-Ulrich Moritz, Bendesdorf (DE); Heinz-Peter Rink, Munster (DE); Thomas Kruger, Eisingen (DE); Stephan Schwarte, Emsdetten (DE); Wilma Locken, Haltern (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/239,540

(22) PCT Filed: Apr. 6, 2001
(86) PCT No.: PCT/EP01/03933

(30) Foreign Application Priority Data
Apr. 8, 2000 (DE) 100-17-653.4

(51) Int. Cl. B32B 27/00

(52) U.S. Cl. 428/422.8; 428/500

(57) ABSTRACT

Graft copolymers based on polyurethane, preparable by graft copolymerizing at least one hydrophobic or hydrophilic polyurethane containing on average at least one thiol group with at least one olefinically unsaturated monomer in solution or in an aqueous dispersion, and the use of the graft copolymers for preparing aqueous dispersions, coating materials, adhesives, and sealing compounds.

The present invention relates to novel graft copolymers based on polyurethane. The present invention further relates to the preparation of the novel graft copolymers based on polyurethane. The present invention additionally relates to novel dispersions comprising the novel graft copolymers based on polyurethane. Furthermore, the present invention relates to the use of the novel graft copolymers based on polyurethane, and their dispersions for preparing novel coating materials, adhesives, and sealing compounds. The present invention also relates to the production of new coatings, adhesives and seals on and in primed and unprimed substrates. The present invention relates not least to the primed and unprimed substrates coated with a novel coating, bonded with a novel adhesive film, and/or sealed with a novel seal.

Graft copolymers based on polyurethane are known. They are normally made by the graft copolymerization of olefinically unsaturated monomers in the aqueous dispersion of a hydrophilic or hydrophobic polyurethane whose polymer chain contains terminal and/or lateral, olefinically unsaturated groups. Groups of this kind can be incorporated

into the polyurethane chain by way of maleic acid or fumaric acid and/or their esters,

laterally to the polyurethane chain by way of compounds having two isocyanate-reactive groups and at least one olefinically unsaturated group or by way of compounds having two isocyanate groups and at least one olefinically unsaturated group,

terminally to the polyurethane chain by way of compounds having one isocyanate-reactive group and at least one olefinically unsaturated group or by way of compounds having one isocyanate group and at least one olefinically unsaturated group, or

by way of anhydrides of alpha, beta-unsaturated carboxylic acids.

By way of example, reference is made to the Patent Applications and Patents DE 197 22 862 C2, DE 196 45 761 A1, EP 0 401 565 A1, EP 0 522 420 A1, EP 0 522 419 A2, EP 0 755 946 A1, EP 0 608 021 A1, EP 0 708 788 A1or EP 0 730 613 A1, and also the German Patent Applications DE 199 53 446.2, DE 199 53 445.2, and DE 199 53 203.6 unpublished at the priority date of the present specification.

In the context of the present invention, the property of hydrophilicity denotes the constitutional property of a molecule or functional group to penetrate into the aqueous phase or to remain therein. Accordingly, in the context of the present invention, the property of hydrophobicity denotes the constitutional property of a molecule or functional group to behave exophilically with respect to water, i.e., to tend not to penetrate into water or to tend to depart the aqueous phase. Supplementarily, reference is made to Römpp Lexikon Lacke und Druckfarben, Georg Thieme Verlag, Stuttgart, New York, 1998 “Hydrophilicity”, “Hydrophobicity”, pages 294 and 295.

The known graft copolymers based on polyurethane are used especially for the preparation of waterborne coating materials. The known waterborne coating materials serve primarily to produce color and/or effect basecoats in multicoat coatings by the wet-on-wet process, as are described, for example, in the patents and patent applications recited above.

Nevertheless, the preparation of the known graft copolymers based on polyurethane may give rise to problems.

Thus, lateral and/or terminal allyl groups are often incorporated as grafting centers. However, the reactivity of the allyl groups is comparatively low. If the more reactive acrylate or methacrylate groups are used instead, gelling of the polyurethanes may occur before or during the graft copolymerization.

In some cases it is possible, not least, for the amount of olefinically unsaturated groups in the polyurethanes to prove too low for complete grafting, with the consequence that a large proportion of the monomers intended for grafting on forms separate homopolymers and/or copolymers alongside the polyurethane, which may adversely affect the performance properties of the graft copolymers and of the coating materials, adhesives, and sealing compounds prepared using them. This disadvantage cannot be readily removed by raising the double-bond fraction in the polyurethanes to be grafted, since to do so is detrimental to other important performance properties of the polyurethanes.

Polyurethanes containing thiol groups, especially terminal thiol groups, are known.

Patent Application DD 298 645 A5 discloses thiourethane pre-polymers with α,ω-terminated multiple bands which are reactive to high-energy radiation and also ionic or free-radical addition reactions. They are used as adhesives, curable films or reactive diluents which are added to polymerizable monomers as thickeners.

German Patent Application DE 31 21 384 A1 relates to processes for preparing oligourethanes with terminal mercapto groups which are used as binders for oxidatively curable coating and sealing compositions or as additives for epoxy resins.

Patent Application EP 0 465 070 B1 discloses the preparation of graft copolymers by grafting unsaturated monomers onto thio- and hydroxy-functional polyurethanes. There reaction products are used as binders in dispersions for magnetic recording media.

German Patent Application DE 40 17 940 A1 discloses alpha,omega-difunctional prepolymers containing terminal thiol groups and, in the chain, thiocarbamate groups. They are prepared by reacting dithiols with diisocyanates. They may be used to produce linear polymers, networks, casting resins, composites, laminates, adhesives, coatings, coating materials, and as starting materials for preparing high molecular mass thermoplastic materials. Details relating to these applications, however, are not stated.

German Patent Application DE 35 08 428 A1 discloses oligourethanes having terminal thiol groups. They are prepared by reacting polyisocyanates with a substoichiometric amount of polyols and mercaptoalkanols. They are used as binders for oxidatively curable coating materials and sealing compounds, as additives for epoxy resins, or as crosslinkers for plastics, or plastics precursors, containing olefinically unsaturated compounds.

German Patent Application DE 21 21 478 A1 discloses a process for crosslinking addition polymers which contain thiol groups. The crosslinkers used are nitrile N-oxides or precursors thereof such as poly(hydroxamoyl halides).

German Patent Application DE 34 07 031 A1 discloses a process for preparing chemically curable or water-vulcanizable adhesives, coating materials, sealing compounds and casting compositions based on polyurethanes. In this process, prepolymers containing free isocyanate groups are reacted with prepolymers containing thiol groups that are obtainable by reacting the prepolymers containing free isocyanate groups with mercaptoalkanols.

German Patent Application DE 20 28 892 A1 discloses a curable composition comprising a constituent having two or more olefinically or acetylenically unsaturated bonds, and a polythiol as crosslinker. The reaction between these constituents can be accelerated by means of alpha-hydroxy carboxylic acids.

It is an object of the present invention to provide novel graft copolymers based on polyurethane which no longer have the disadvantages of the prior art but which can be prepared simply and in a targeted manner from readily available hydrophilic and hydrophobic polyurethane grafting bases in high grafting yields without a proportion of the olefinically unsaturated monomers intended for grafting on forming disruptive amounts of separate homopolymers and/or copolymers alongside the polyurethane. The novel graft copolymers based on polyurethane should be suitable for the preparation of aqueous coating materials, adhesives, and sealing compounds which on primed and unprimed substrates give coatings, adhesive films and seals whose profile of properties at least matches, if not exceeds, that of the coatings, adhesive films and seals known to date.

Accordingly, the novel graft copolymer based on polyurethane has been found, which can be prepared by graft copolymerizing at least one hydrophobic or hydrophilic polyurethane containing on average at least one thiol group with at least one olefinically unsaturated monomer in a solution or in an aqueous dispersion.

In the text below, the novel graft copolymer based on polyurethane is referred to as “graft copolymer of the invention”.

Also found has been the novel process for preparing a graft copolymer based on polyurethane by graft copolymerizing at least one hydrophilic or hydrophobic polyurethane with at least one olefinically unsaturated monomer, which is referred to below as the process of the invention.

Additionally found has been the novel aqueous dispersion of the graft copolymer of the invention, which is referred to below as “dispersion of the invention”.

Additionally found have been the novel coating materials, adhesives and sealing compounds based on the graft copolymer of the invention or on the dispersion of the invention, which are referred to below as “coating materials, adhesives and sealing compounds of the invention”.

Also found, moreover, have been the novel coatings, adhesive films and seals on primed and unprimed substrates, which are referred to below as “coatings, adhesive films and seals of the invention”.

Further items provided by the present invention will emerge from the description.

In the light of the prior art, it was surprising that the complex object on which the present invention is based could be elegantly achieved by means of the graft copolymers of the invention. It was even more surprising that the process of the invention requires no particular new apparatus or technical measures, but that the process measures and apparatus known from the prior art can be employed. In this context it should be emphasized that the process of the invention is not accompanied by the technical and safety problems associated with the use of olefinically unsaturated polyurethanes, such as the gelling of the batch. Even more surprising was the extremely broad applicability of the graft copolymers of the invention and of the dispersions of the invention.

The preparation of the graft copolymer of the invention starts from at least one, preferably hydrophilic or hydrophobic polyurethane which contains on average at least one, preferably at least two, terminal and/or lateral, but especially terminal, thiol group(s) or mercapto group(s) in the molecule. This means that the polyurethane contains on average a nonintegral number, e.g., 1.2, 1.5, 1.8, 2.1, 2.5, 3.2, 3.5 or 3.8, or on average an integral number, e.g., 1, 2, 3 or 4, thiol groups in the molecule. In accordance with the invention it is of advantage if the polyurethane contains on average at least two thiol groups. Preferably, there are not more than five thiol groups, with particular preference not more than four, and in particular not more than three thiol groups present.

The polyurethanes containing thiol groups for use in accordance with the invention are linear, star-branched or comb-shaped, but especially linear, in construction. In addition to the thiol groups essential to the invention, they may contain further functional groups.

For instance, both the hydrophilic and the hydrophobic polyurethanes may contain reactive functional groups which render the resultant graft copolymers of the invention thermally self-crosslinking or externally crosslinking. A precondition, however, is that these reactive functional groups do not disrupt or inhibit the graft copolymerization.

The hydrophilic polyurethanes generally contain either

(f1) functional groups which can be converted into cations by neutralizing agents and/or quaternizing agents, and/or cationic groups, especially tertiary sulfonium groups, or

(f2) functional groups which can be converted into anions by neutralizing agents, and/or anionic groups, especially carboxylic acid and/or carboxylate groups,

and/or

(f3) nonionic hydrophilic groups, especially poly(alkylene ether) groups,

which promote the dispersibility of the polyurethanes and of the graft copolymers of the invention in water.

Examples of suitable functional groups (f1) for use in accordance with the invention, which can be converted into cations by neutralizing agents and/or quaternizing agents, are primary, secondary or tertiary amino groups, secondary sulfide groups or tertiary phosphine groups, especially tertiary amino groups or secondary sulfide groups.

Examples of suitable cationic groups (f1) for use in accordance with the invention are primary, secondary, tertiary or quaternary ammonium groups, tertiary sulfonium groups or quaternary phosphonium groups, preferably quaternary ammonium groups or tertiary sulfonium groups, but especially tertiary sulfonium groups.

Examples of suitable functional groups (f2) for use in accordance with the invention, which can be converted into anions by neutralizing agents, are carboxylic acid, sulfonic acid or phosphonic acid groups, especially carboxylic acid groups.

Examples of suitable anionic groups (f2) for use in accordance with the invention are carboxylate, sulfonate or phosphonate groups, especially carboxylate groups.

Examples of suitable neutralizing agents for functional groups (f1) convertible into cations are organic and inorganic acids, such as sulfuric acid, hydrochloric acid, phosphoric acid, formic acid, acetic acid, lactic acid, dimethylolpropionic acid, and citric acid.

Examples of suitable neutralizing agents for functional groups (f2) convertible into anions are ammonia or amines, such as trimethylamine, triethylamine, tributylamine, dimethylaniline, diethylaniline, triphenylamine, dimethylethanolamine, diethylethanolamine, methyldiethanolamine, 2-aminomethylpropanol, dimethylisopropylamine, dimethylisopropanolamine, and triethanolamine, for example. Preferred neutralizing agents used are dimethylethanolamine and/or triethylamine.

Advantageously, the polyurethane containing thiol groups, depending on the nature of the stabilization, has an acid number or amine number of from 10 to 250 mg KOH/g (ionic stabilization or nonionic plus ionic stabilization) or of from 0 to 10 mg KOH/g (nonionic stabilization), an OH number of from 30 to 350 mg KOH/g, and a number-average molecular weight of from 1500 to 55,000 daltons.

The polyurethanes containing thiol groups can be prepared by any desired, customary and known methods of polyurethane chemistry. In accordance with the invention, however, it is of advantage to prepare them by reacting a polyurethane prepolymer having at least one, preferably at least two and, in particular, two free isocyanate groups in the molecule with at least one polythiol and/or at least one compound having at least one thiol group and at least one hydroxyl group. The polyurethane prepolymers are linear, star-branched or comb-shaped polymers or oligomers. It is preferred to use linear polyurethane prepolymers.

In the context of the present invention the term oligomers as used here and below refers to resins containing at least 2 to 15 monomer units in their molecule. In the context of the present invention the term polymers refers to resins containing at least 10 monomer units in their molecule. Supplementarily, reference in relation to these terms is made to Römpp Lexikon Lacke und Druckfarben, Georg Thieme Verlag, Stuttgart, New York, 1998, “Oligomers”, page 425.

The polythiols contain at least two thiol groups. However, it is also possible to employ polythiols containing three or four thiol groups such as pentaerythritol tetrakis(beta-mercaptopropionate). In that case, however, care should be taken to ensure that the reaction mixture in question does not gel. It is preferred to employ dithiols. Examples of suitable dithiols are described in German Patent Application DE 40 17 940 A1, page 3, lines 13 to 34.

In accordance with the invention, the compounds having at least one thiol group and at least one hydroxyl group in the molecule are preferred. It is preferred to use compounds containing one thiol group and two hydroxyl groups, especially 2,2-dimethylolethanethiol or 2,2-dimethylolpropanethiol, which also permit the introduction of lateral thiol groups into the polyurethanes. It is preferred to use compounds containing one thiol group and one hydroxyl group, especially mercaptoethanol or mercaptopropanol, by means of which terminal thiol groups are introduced.

The reaction of the polyurethane prepolymers with the compounds containing thiol groups has no peculiarities as to method but takes place in accordance with the customary and known methods of the chemistry of organic polyisocyanates, as are described, for example, in the German Patent Applications DE 34 07 031 A1 or DE 40 17 940 A1. Usually, the reaction is continued until free isocyanate groups can no longer be detected.

The polyurethane prepolymer is linear, star-branched or comblike, but especially linear, in construction. In this. case the linear polyurethane prepolymer contains preferably two free isocyanate groups, in particular two terminal free isocyanate groups. The branched polyurethane prepolymers or polyurethane prepolymers of comblike construction contain preferably at least two, in particular more than two, free isocyanate groups, preference being given to terminal free isocyanate groups.

In terms of method, the preparation of the polyurethane prepolymers for use in accordance with the invention has no peculiarities, but takes place, for example, as described in Patents EP 0 089 497 B1 or EP 0 228 003 B1, by the reaction of at least one polyisocyanate, in particular a diisocyanate, with at least one polyol, in particular a diol, the isocyanate component being employed in a molar excess, so that terminal free isocyanate groups result.

For the preparation of the polyurethane prepolymers it is preferred to use diisocyanates and also, in minor amounts if desired, polyisocyanates for introducing branching sites. In the context of the present invention, minor amounts are amounts which do not cause gelling of the polyurethane prepolymers during their preparation. Gelling may also be prevented by the concomitant use of small amounts of monoisocyanates.

Examples of suitable diisocyanates are isophorone diisocyanate (=5-isocyanato-1-isocyanatomethyl-1,3,3-trimethylcyclohexane), 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′ -diisocyanate, trimethylene diisocyanate, tetramethylene diisocyanate, pentamethylene diisocyanate, hexamethylene diisocyanate, ethylethylene diisocyanate, trimethylhexane diisocyanate, heptanemethylene diisocyanate or diisocyanates derived from dimeric fatty acids, as sold by the company Henkel under the commercial designation DDI 1410 and described in the Patents DO 97/49745 and WO 97/49747, especially 2-heptyl-3,4-bis(9-isocyanatononyl)-1-pentylcyclohexane, or 1,2-, 1,4- or 1,3-bis(isocyanatomethyl)cyclohexane, 1,2-, 1,4- or 1,3-bis(2-isocyanatoeth-1-yl)cyclohexane, 1,3-bis(3-isocyanatoprop-1-yl)cyclohexane, 1,2-, 1,4- or 1,3-bis(4-isocyanatobut-1-yl)-cyclohexane, liquid bis(4-isocyanatocyclohexyl)methane with a trans/trans content of up to 30% by weight, preferably 25% by weight, and in particular 20% by weight, as is described in Patents DE 44 14 032 A1, GB 1 220 717 A1, DE-A-16 18 795 or DE 17 93 785 A1; tolylene diisocyanate, xylylene diisocyanate, bisphenylene diisocyanate, naphthylene diisocyanate or diphenylmethane diisocyanate.

Examples of suitable polyisocyanates are the isocyanurates of the diisocyanates described above.

Examples of particularly suitable monoisocyanates are phenyl isocyanate, cyclohexyl isocyanate, stearyl isocyanate, vinyl isocyanate, methacryloyl isocyanate and/or 1-(1-isocyanato-1-methylethyl)-3-(1-methylethenyl) benzene (TMI® from the company CYTEC).

Examples of suitable polyols are saturated or olefinically unsaturated polyester polyols which are prepared by reacting

optionally sulfonated saturated and/or unsaturated polycarboxylic acids or their esterifiable derivatives, alone or together with monocarboxylic acids, and

saturated and/or unsaturated polyols, alone or together with monools.

Examples of suitable polycarboxylic acids are aromatic, aliphatic and cycloaliphatic polycarboxylic acids. Preference is given to the use of aromatic and/or aliphatic polycarboxylic acids.

Examples of suitable aromatic polycarboxylic acids are phthalic acid, isophthalic acid, terephthalic acid, phthalic, isophthalic or terephthalic monosulfonate, or halophthalic acids, such as tetrachlorophthalic or tetrabromophthalic acid, among which isophthalic acid is advantageous and is therefore used with preference.

Examples of suitable acyclic aliphatic or unsaturated polycarboxylic acids are oxalic acid, malonic acid, succinic acid, glutaric acid, adipic acid, pimelic acid, suberic acid, azelaic acid, sebacic acid, undecanedicarboxylic acid or dodecanedicarboxylic acid or maleic acid, fumaric acid or itaconic acid, of which adipic acid, glutaric acid, azelaic acid, sebacic acid, dimeric fatty acids and maleic acid are advantageous and are therefore used with preference.

Examples of suitable cycloaliphatic and cyclic unsaturated polycarboxylic acids are 1,2-cyclobutanedicarboxylic acid, 1,3-cyclobutanedicarboxylic acid, 1,2-cyclopentanedicarboxylic acid, 1,3-cyclopentanedicarboxylic acid, hexahydrophthalic acid, 1,3-cyclohexanedicarboxylic acid, 1,4-cyclohexanedicarboxylic acid, 4-methylhexahydrophthalic acid, tricyclodecanedicarboxylic acid, tetrahydrophthalic acid or 4-methyltetrahydrophthalic acid. These dicarboxylic acids can be used both in their cis and in their trans forms and also as a mixture of both forms.

Further examples of suitable polycarboxylic acids are polymeric fatty acids, especially those having a dimer content of more than 90% by weight, which are also known as dimeric fatty acids.

Also suitable are the esterifiable derivatives of the abovementioned polycarboxylic acids, such as their monoesters or polyesters with aliphatic alcohols having 1 to 4 carbon atoms, for example. It is also possible to use the anhydrides of the abovementioned polycarboxylic acids, where they exist.

Together with the polycarboxylic acids it is possible if desired to use monocarboxylic acids as well, such as, for example, benzoic acid, tert-butylbenzoic acid, lauric acid, isononanoic acid, or fatty acids from naturally occurring oils, and also acrylic acid, methacrylic acid, ethacrylic acid or crotonic acid. The preferred monocarboxylic acid used is isononanoic acid.

Examples of suitable polyols are diols and trials, especially dials. Normally, triols are used alongside the diols in minor amounts in order to introduce branching sites into the polyester polyols. In the context of the present invention, minor amounts are amounts which do not cause gelling of the polyester polyols during their preparation.

Examples of suitable dials are ethylene glycol, 1,2- or 1,3-propanediol, 1,2-, 1,3- or 1,4-butanediol, 1,2-, 1,3-, 1,4- or 1,5-pentanediol, 1,2-, 1,3-, 1,4-, 1,5- or 1,6-hexanediol, neopentyl hydroxypivalate, neopentyl glycol, diethylene glycol, 1,2-, 1,3- or 1,4-cyclohexanediol, 1,2-, 1,3- or 1,4-cyclohexanedimethanol, trimethylpentanediol, ethylbutylpropanediol, the positionally isomeric diethyloctanediols, 2-butyl-2-ethyl-1,3-propanediol, 2-butyl-2-methyl-1,3-propanediol, 2-phenyl-2-methyl-1,3-propanediol, 2-propyl-2-ethyl-1,3-propanediol, 2-di-tertbutyl-1,3-propanediol, 2-butyl-2-propyl-1,3-propanediol, 1-dihydroxymethylbicyclo[2.2.1]heptane, 2,2-diethyl-1,3-propanediol, 2,2-dipropyl-1,3-propanediol, 2-cyclohexyl-2-methyl-1,3-propanediol, 2,5-dimethyl-2,5-hexanediol, 2,5-diethyl-2,5-hexanediol, 2-ethyl-5-methyl-2,5-hexanediol, 2,4-dimethyl-2,4-pentanediol, 2,3-dimethyl-2,3-butanediol, 1,4-(2′ -hydroxypropyl)benzene or 1,3-(2′ -hydroxypropyl)benzene.

Of these diols, 1,6-hexanediol and neopentyl glycol are particularly advantageous and are therefore used with particular preference.

The abovementioned diols can also be used directly as diols for the preparation of the polyurethane prepolymers (B1).

Examples of suitable triols are trimethylolethane, trimethylolpropane or glycerol, especially trimethylolpropane.

The abovementioned triols can also be used directly as triols for the preparation of the polyurethane prepolymers (cf. Patent EP 0 339 433 A1).

If desired, minor amounts of monools can also be used. Examples of suitable monools are alcohols or phenols, such as ethanol, propanol, n-butanol, sec-butanol, tert-butanol, amyl alcohols, hexanols, fatty alcohols, phenol, or allyl alcohol.

The polyester polyols can be prepared in the presence of small amounts of a suitable solvent as entrainer. Examples of entrainers used are aromatic hydrocarbons, such as especially xylene and (cyclo)aliphatic hydrocarbons, e.g., cyclohexane or methylcyclohexane.

Further examples of suitable polyols are polyester dials which are obtained by reacting a lactone with a dial. They are notable for the presence of terminal hydroxyl groups and repeating polyester fractions of the formula —(—CO—(CHR)ₘ—CH₂—O—)—. Here, the index m is preferably from 4 to 6 and the substituent R is hydrogen or an alkyl, cycloalkyl or alkoxy radical. No substituent contains more than 12 carbon atoms. The total number of carbon atoms in the substituent does not exceed 12 per lactone ring. Examples are hydroxycaproic acid, hydroxybutyric acid, hydroxydecanoic acid, and/or hydroxystearic acid.

Preferred for the preparation of the polyester dials is the unsubstituted epsilon-caprolactone, where m is 4 and all substituents R are hydrogen. The reaction with lactone is initiated by low molecular mass polyols such as ethylene glycol, 1,3-propanediol, 1,4-butanediol or dimethylolcyclohexane. It is also possible, however, to react other reaction components, such as ethylenediamine, alkyldialkanolamines or else urea, with caprolactone. Other suitable dials of relatively high molecular mass are polylactam dials, which are prepared by reacting, for example, epsilon-caprolactam with low molecular mass dials.

Other examples of suitable polyols include polyether polyols, especially those having a number-average molecular weight of from 400 to 5000, in particular from 400 to 3000. Examples of particularly suitable polyether diols are polyether diols of the general formula H—(—O—(CHR¹)ₒ—)ₚOH, where the substituent R¹ is hydrogen or a lower, substituted or unsubstituted alkyl radical, the index o is from 2 to 6, preferably from 3 to 4, and the index p is from 2 to 100, preferably from 5 to 50. Especially suitable examples are linear or branched polyether diols such as poly(oxyethylene) glycols, poly(oxypropylene) glycols and poly(oxybutylene) glycols.

By means of the polyether diols it is possible to introduce the nonionic hydrophilic functional groups (a3), or a portion thereof, into the main chain(s) of the polyurethane prepolymers.

For the preparation of the polyurethane prepolymers it is also possible to use further starting compounds in order advantageously to vary the profile of properties of the polyurethanes containing thiol groups and of the graft copolymers of the invention.

If it is intended that the graft copolymers of the invention should have self-crosslinking properties, then it is possible to use at least one compound having at least one blocked isocyanate group and at least two isocyanate-reactive functional groups. Examples of suitable isocyanate-reactive groups are —SH, —NH₂, >NH, —OH, —O—(CO)—NH—(CO)—NH₂ or —O—(CO)—NH₂, of which the primary and secondary amino groups and the hydroxyl group are of advantage and the hydroxyl groups are of particular advantage. Examples of suitable blocking agents are the blocking agents known from U.S. Patent U.S. Pat. No. 4,444,954 A1, of which the oximes and ketoximes xiii), especially the ketoximes xiii), specifically methyl ethyl ketoxime, offer particular advantages and are therefore used with particular preference. Alternatively, the blocked isocyanate groups may result from the reaction of the free isocyanate groups of the polyurethane prepolymer with the blocking agents.

In order to introduce olefinically unsaturated groups—where used—it is possible to use at least one compound having at least one olefinically unsaturated group and at least two isocyanate-reactive functional groups. Examples of suitable isocyanate-reactive functional groups are those described above. Examples of suitable olefinically unsaturated groups and compounds for introducing them are described in the Patent Applications and Patents DE 197 22 862 C2, DE 196 45 761 A1, EP 0 401 565 A1, EP 0 522 420 A1, EP 0 522 419 A2, EP 0 755 946 A1, EP 0 608 021 A1, EP 0 708 788 A1 or EP 0 730 613 A1, and also the German Patent Applications DE 199 53 446.2, DE 199 53 445.2, and DE 199 53 203.6 unpublished at the priority date of the present specification. Alternatively, the olefinically unsaturated groups can be introduced by way of the above-described compounds having at least one olefinically unsaturated group and one isocyanate group.

For the preparation of the hydrophilic polyurethanes containing thiol groups, compounds having at least one hydrophilic functional group and at least one isocyanate-reactive functional group are additionally incorporated into the polyurethane prepolymers.

The introduction of hydrophilic functional (potentially) cationic groups (f1) into the polyurethane prepolymers is made by way of the incorporation of compounds which contain at least one, especially two, isocyanato-reactive groups and at least one group capable of forming cations in the molecule; the amount to be used can be calculated from the target amine number.

Suitable isocyanato-reactive groups are the groups described above, especially hydroxyl groups, and also primary and/or secondary amino groups, of which the hydroxyl groups are used with preference.

Examples of suitable compounds of this kind are 2,2-dimethylolethyl- or -propylamine blocked with a ketone, the resulting ketoxime group being hydrolyzed again before the formation of the cationic group (f1), or N,N-dimethyl-, N,N-diethyl- or N-methyl-N-ethyl-2,2-dimethylolethyl- or -propylamine.

The introduction of hydrophilic functional (potentially) anionic groups (f2) into the polyurethane prepolymers is made by way of the incorporation of compounds which contain at least one isocyanato-reactive and at least one group capable of forming anions in the molecule; the amount to be used can be calculated from the target acid number.

Examples of suitable compounds of this kind are those containing two isocyanato-reactive groups in the molecule. Suitable isocyanato-reactive groups are, in particular, hydroxyl groups and also primary and/or secondary amino groups. Accordingly, for example, it is possible to use alkanoic acids having two substituents on the alpha carbon atom. The substituent can be a hydroxyl group, an alkyl group or, preferably an alkylol group. These alkanoic acids have at least one, generally from 1 to 3, carboxyl groups in the molecule. They have from 2 to about 25, preferably from 3 to 10, carbon atoms. Examples of suitable alkanoic acids are dihydroxypropionic acid, dihydroxysuccinic acid and dihydroxybenzoic acid. A particularly preferred group of alkanoic acids are the alpha, alpha-dimethylol-alkanoic acids of the general formula R²—C(CH₂OH)₂COOH, where R² is a hydrogen atom or an alkyl group having up to about 20 carbon atoms. Examples of particularly suitable alkanoic acids are 2,2-dimethylolacetic acid, 2,2-dimethylolpropionic acid, 2,2-dimethylolbutyric acid and 2,2-dimenthylolpentanoic acid. The preferred dihydroxyalkanoic acid is 2,2-dimethylolpropionic acid. Examples of compounds containing amino groups are α,δ-diaminovaleric acid, 3,4-diaminobenzoic acid, 2,4-diaminotoluenesulfonic acid and 2,4-diaminodiphenyl ether sulfonic acid.

Hydrophilic functional nonionic poly(oxyalkylene) groups (f3) can be introduced as lateral or terminal groups into the polyurethane molecules. For this purpose it is possible to use not only the polyether diols described above but also, for example, alkoxypoly(oxyalkylene) alcohols having the general formula R³O—(—CH₂—CHR⁴—O—)ᵣH where R³ is an alkyl radical having 1 to 6 carbon atoms, R⁴ is a hydrogen atom or an alkyl radical having 1 to 6 carbon atoms, and the index r is a number between 20 and 75 (cf. the Patent Applications EP 0 354 261 A1 or EP 0 424 705 A2).

The selection of the hydrophilic functional groups (f1) or (f2) should be made so as to rule out any disruptive reactions, such as, for instance, salt formation or crosslinking with the functional groups which may be present in the other starting compounds and/or constituents of the polyurethanes containing thiol groups or of the graft copolymers, dispersions, coating materials, sealing compounds or adhesives of the invention. The skilled worker will therefore be able to make the selection in a simple manner on the basis of his or her technical knowledge.

Of these hydrophilic functional (potentially) ionic groups (f1) and (f2), and the hydrophilic functional nonionic groups (f3), the (potentially) anionic groups (f2) are advantageous and are therefore used with particular preference.

The preparation of the polyurethane prepolymers from the starting compounds described above likewise has no peculiarities as to method, but takes place in bulk or in an inert organic medium, preferably in an inert organic medium, preference being given to the use of polar organic solvents, especially water-miscible solvents such as ketones, esters, ethers, cyclic amides or sulfoxides. This reaction can be carried out in a plurality of stages or in one stage. It is essential that the reaction is continued until the free isocyanate group content is constant.

The polyurethanes containing thiol groups are used to prepare the graft copolymers of the invention.

For this purpose, the polyurethanes containing thiol groups are grafted in organic solution or in a dispersion with at least one monomer (a).

If grafting is carried out in organic solution, this has the advantage that this process step can be carried out immediately after the preparation of the polyurethane containing thiol groups, i.e., without an intermediate dispersing step. In certain circumstances, this makes it easier to isolate the graft copolymers of the invention for particular applications. The customary and known methods of solution polymerization may be employed in this case.

In accordance with the invention it is of advantage to react the polyurethanes containing thiol groups in dispersion in an aqueous medium, especially when the resulting graft copolymers of the invention are used to prepare aqueous coating materials, adhesives and sealing compounds.

The aqueous medium contains essentially water. The aqueous medium may contain minor amounts of organic solvents, neutralizing agents, crosslinkers and/or customary coatings additives and/or other dissolved solid, liquid or gaseous organic and/or inorganic substances of low and/or high molecular mass. In the context of the present invention, the term “minor amount” means an amount which does not change the aqueous character of the aqueous medium. The aqueous medium, however, may also be pure water.

For the purpose of dispersion, the hydrophilic polyurethanes containing thiol groups, which contain the (potentially) ionic hydrophilic functional groups (f1) or (f2) described above, are neutralized with at least one of the above-described neutralizing agents and subsequently dispersed. In the case of the hydrophilic polyurethanes containing thiol groups which contain only the nonionic hydrophilic functional groups (f3), the use of neutralizing agents is unnecessary.

The hydrophobic polyurethanes containing thiol groups can also be dispersion in an aqueous medium. This is advantageously carried out in a strong shear field. Viewed methodically, this process has no peculiarities, but can be carried out, for example, in accordance with the microfluidizer dispersion technique described in European Patent Application EP 0 401 565 A1.

Examples of monomers (a) suitable for preparing the graft copolymers of the invention are the following:

Monomers (a1):

Hydroxyalkyl esters of acrylic acid, methacrylic acid or another alpha, beta-ethylenically unsaturated carboxylic acid which are derived from an alkylene glycol which is esterified with the acid, or are obtainable by reacting the acid with an alkylene oxide, especially hydroxyalkyl esters of acrylic acid, methacrylic acid, crotonic acid or ethacrylic acid in which the hydroxyalkyl group contains up to 20 carbon atoms, such as 2-hydroxyethyl, 2-hydroxypropyl, 3-hydroxypropyl, 3-hydroxybutyl or 4-hydroxybutyl acrylate, methacrylate, ethacrylate or crotonate; 1,4-bis(hydroxymethyl)cyclohexane, octahydro-4,7-methano-1H-indenedimethanol or methylpropanediol monoacrylate, monomethacrylate, monoethacrylate or monocrotonate; or reaction products of cyclic esters, such as epsilon-caprolactone, for example, and these hydroxyalkyl esters; or olefinically unsaturated alcohols such as allyl alcohol or polyols such as trimethylolpropane monoallyl or diallyl ether or pentaerythritol monoallyl, diallyl or triallyl ether. These monomers (a1) of higher functionality are generally used only in minor amounts. In the context of the present invention, minor amounts of higher-functional monomers are amounts which do not result in the crosslinking or gelling of the polyacrylate resins, except where the graft copolymers of the invention are to be present in the form of crosslinked microgel particles.

Monomers (a2):

(Meth)acrylic, crotonic or ethacrylic alkyl or cycloalkyl esters having up to 20 carbon atoms in the alkyl radical, especially methyl, ethyl, propyl, n-butyl, sec-butyl, tert-butyl, hexyl, ethylhexyl, stearyl and lauryl acrylate, methacrylate, crotonate or ethacrylate; cycloaliphatic (meth)acrylic, crotonic or ethacrylic esters, especially cyclohexyl, isobornyl, dicyclopentadienyl, octahydro-4,7-methano-1H-indenemethanol or tert-butylcyclohexyl (meth)acrylate, crotonate or ethacrylate; (meth)acrylic, crotonic or ethacrylic oxaalkyl or oxacycloalkyl esters such as ethyltriglycol (meth) acrylate and methoxyoligoglycol (meth)acrylate having a molecular weight Mn of preferably 550; or other ethoxylated and/or propoxylated hydroxyl-free (meth)acrylic, crotonic or ethacrylic acid derivatives. These may include, in minor amounts, higher-functional (meth)acrylic, crotonic or ethacrylic alkyl or cycloalkyl esters such as ethylene glycol, propylene glycol, diethylene glycol, dipropylene glycol, butylene glycol, 1,5-pentanediol, 1,6-hexanediol, octahydro-4,7-methano-1H-indenedimethanol or cyclohexane-1,2-, -1,3- or -1,4-diol di(meth)acrylate; trimethylolpropane di- or tri(meth)acrylate; or pentaerythritol di-, tri- or tetra(meth)acrylate, and also the analogous ethacrylates or crotonates. In the context of the present invention, minor amounts of higher-functional monomers (a2) are amounts which do not cause crosslinking or gelling of the polyacrylate resins, except where the graft copolymers of the invention are to be present in the form of crosslinked microgel particles.

Monomers (a3):

Ethylenically unsaturated monomers carrying at least one acid group, preferably a carboxyl group, per molecule, or a mixture of such monomers. As component (a3) it is particularly preferred to use acrylic acid and/or methacrylic acid. However, other ethylenically unsaturated carboxylic acids having up to 6 carbon atoms in the molecule can also be used. Examples of such acids are ethacrylic acid, crotonic acid, maleic acid, fumaric acid and itaconic acid. It is also possible to use ethylenically unsaturated sulfonic or phosphonic acids, and/or their partial esters, as component (a3) . Further suitable monomers (a3) include maleic acid mono(meth)acryloyloxyethyl ester, succinic acid mono(meth)acryloyloxyethyl ester and phthalic acid mono(meth)acryloyloxyethyl ester, and also vinylbenzoic acid (all isomers), alpha-methylvinylbenzoic acid (all isomers) or vinylbenzenesulfonic acid (all isomers).

Monomers (a4):

Vinyl esters of alpha-branched monocarboxylic acids having 5 to 18 carbon atoms in the molecule. The branched monocarboxylic acids can be obtained by reacting formic acid or carbon monoxide and water with olefins in the presence of a liquid, strongly acidic catalyst; the olefins can be cracking products from paraffinic hydrocarbons, such as mineral oil fractions, and can contain both branched and straight-chain acyclic and/or cycloaliphatic olefins. In the reaction of such olefins with formic acid and/or with carbon monoxide and water, a mixture of carboxylic acids is formed in which the carboxyl groups are located predominantly on a quaternary carbon atom. Other olefinic starting materials are, for example propylene trimer, propylene tetramer, and diisobutylene. Alternatively, the vinyl esters can be prepared in a conventional manner from the acids, for example, by reacting the acid with acetylene. Particular preference—owing to their ready availability—is given to the use of vinyl esters of saturated aliphatic monocarboxylic acids having 9 to 11 carbon atoms and being branched on the alpha carbon atom.

Monomers (a5):

Reaction product of acrylic acid and/or methacrylic acid with the glycidyl ester of an alpha-branched monocarboxylic acid having 5 to 18 carbon atoms per molecule. The reaction of the acrylic or methacrylic acid with the glycidyl ester of a carboxylic acid having a tertiary alpha carbon atom can take place before, during or after the polymerization reaction. As component (a5) it is preferred to use the reaction product of acrylic and/or methacrylic acid with the glycidyl ester of Versatic® acid. This glycidyl ester is obtainable commercially under the name Cardura® E10. Further details are given in Römpp Lexikon Lacke und Druckfarben, Georg Thieme Verlag, Stuttgart, New York, 1998, pages 605 and 606.

Monomers (a6):

Ethylenically unsaturated monomers essentially free of acid groups, such as

olefins such as ethylene, propylene, 1-butene, 1-pentene, 1-hexene, cyclohexene, cyclopentene, norbornene, butadiene, isoprene, cyclopentadiene and/or dicyclopentadiene;

(meth)acrylamides such as (meth)acrylamide, N-methyl-, N,N-dimethyl-, N-ethyl-, N,N-diethyl-, N-propyl-, N,N-dipropyl-, N-butyl-, N,N-dibutyl-, N-cyclohexyl- and/or N,N-cyclohexyl-methyl-(meth)acrylamide and/or N-methylol, N,N-dimethylol, N-methoxymethyl, N,N-di(methoxymethyl), N-ethoxymethyl and/or N,N-di(ethoxyethyl)-(meth)acrylamide, which are used in particular when the graft copolymers of the invention are to have self-crosslinking properties;

monomers containing epoxide groups, such as the glycidyl ester of acrylic acid, methacrylic acid, ethacrylic acid, crotonic acid, maleic acid, fumaric acid and/or itaconic acid;

aminoethyl acrylate, aminoethyl methacrylate, allylamine or N-methyliminoethyl acrylate;

N,N-di(methoxymethyl)aminoethyl acrylate or methacrylate or N,N-di(butoxymethyl)aminopropyl acrylate or methacrylate;

acryloyloxy- or methacryloyloxyethyl-, -propyl- or -butylcarbamate or -allophanate; further examples of suitable monomers containing carbamate groups are described in Patents U.S. Pat. No. 3,479,328 A1, U.S. Pat. No. 3,674,838 A1, U.S. Pat. No. 4,126,747 A1, U.S. Pat. No. 4,279,833 A1 or U.S. Pat. No. 4,340,497 A1;

vinylaromatic hydrocarbons, such as styrene, alpha-alkylstyrenes especially alpha-methylstyrene, arylstyrenes, especially diphenylethylene, and/or vinyltoluene;

nitrites such as acrylonitrile and/or methacrylonitrile;

vinyl compounds such as vinyl chloride, vinyl fluoride, vinylidene dichloride, vinylidene difluoride; N-vinylpyrrolidone; vinyl ethers such as ethyl vinyl ether, n-propyl vinyl ether, isopropyl vinyl ether, n-butyl vinyl ether, isobutyl vinyl ether and/or vinyl cyclohexyl ether; vinyl esters such as vinyl acetate, vinyl propionate, vinyl butyrate, vinyl pivalate, vinyl esters of Versatic® acids, which are sold under the trade name VeoVa® by the company Deutsche Shell Chemie (for further details see Römpp Lexikon Lacke und Druckfarben, Georg Thieme Verlag, Stuttgart, New York, 1998, page 598 and also pages 605 and 606) and/or the vinyl esters of 2-methyl-2-ethylheptanoic acid; and/or

polysiloxane macromonomers having a number-average molecular weight Mn of from 1000 to 40,000, preferably from 2000 to 20,000, with particular preference from 2500 to 10,000 and, in particular, from 3000 to 7000 and having on average from 0.5 to 2.5, preferably from 0.5 to 1.5, ethylenically unsaturated double bonds per molecule, as are described in DE 38 07 571 A1 on pages 5 to 7, in DE 37 06 095 A1 in columns 3 to 7, in EP 0 358 153 B1 on pages 3 to 6, in U.S. Pat. No. 4,754,014 A1 in columns 5 to 9, in DE 44 21 823 A1 or in the International Patent Application WO 92/22615 on page 12 line 18 to page 18 line 10, or acryloxysilane-containing vinyl monomers, preparable by reacting hydroxy-functional silanes with epichlorohydrin and then reacting the reaction product with methacrylic acid and/or hydroxyalkyl esters of (meth)acrylic acid.

From these suitable monomers (a) described above by way of example the skilled worker is easily able to select, on the basis of their known physical and chemical properties and reactivities, the monomers (a) that are particularly suitable for the application in question. For example, he or she may select monomers (a1), (a3) and/or (a6) which introduce the reactive functional groups required for thermal crosslinking. If desired, he or she may for this purpose conduct a few preliminary guideline experiments. In particular, he or she will be careful to ensure that the monomers (a) contain no functional groups, especially (potentially) ionic functional groups, which enter into unwanted interactions and/or chemical reactions with the (potentially) ionic functional groups in the hydrophilic polyurethanes containing thiol groups.

Where the graft copolymers of the invention are to be in the form of crosslinked microgel particles, monomers (a) of relatively high functionality, especially the higher-functional monomers (a1) and/or (a2) described above, are used in amounts which lead to controlled crosslinking of the grafted (co)polymers.

In accordance with the invention, particular advantages result if the monomers (a) are selected such that the profile of properties of the grafted (co)polymers is determined essentially by the above-described (meth)acrylate monomers (a), the other monomers (a) advantageously providing broad variation of this profile of properties.

In accordance with the invention, very particular advantages result from using mixtures of the monomers (a1), (a2) and (a6) and also, if desired, (a3).

From the viewpoint of method, the preparation of the graft copolymers of the invention has no peculiarities; rather, it takes place in accordance with the customary and known methods of free-radical solution polymerization or emulsion polymerization in the presence of at least one polymerization initiator, as described, for example, in the Patent Applications and Patents DE 197 22 862 C2, DE 196 45 761 A1, EP 0 401 565 A1, EP 0 522 420 A1, EP 0 522 419 A2, EP 0 755 946 A1, EP 0 608 021 A1, EP 0 708 788 A1 or EP 0 730 613 A1, and also the German Patent Applications DE 199 53 446.2, DE 199 53 445.2, and DE 199 53 203.6 unpublished at the priority date of the present specification.

In the case of the emulsion polymerization, the monomers (a) can also be brought into the form of a pre-emulsion with the aid of part of a polyurethane dispersion containing thiol groups, and water, and this pre-emulsion is then metered slowly into an initial charge, in which the actual emulsion polymerization proceeds.

Examples of suitable polymerization initiators are initiators which form free radicals, such as dialkyl peroxides, such as di-tert-butyl peroxide or dicumyl peroxide; hydroperoxides such as cumene hydroperoxide or tert-butyl hydroperoxide; per esters, such as tertbutyl perbenzoate, tert-butyl perpivalate, tert-butyl per-3,5,5-trimethylhexanoate or tert-butyl per-2-ethylhexanoate; potassium, sodium or ammonium peroxodisulfate; azo dinitriles such as azobisisobutyronitrile; C—C-cleaving initiators such as benzpinacol silyl ether; or a combination of a non-oxidizing initiator with hydrogen peroxide. It is preferred to use water-soluble initiators. The initiators are used preferably in an amount of from 0.1 to 25% by weight, with particular preference from 0.75 to 10% by weight, based on the overall weight of the monomers (a).

In the solutions or the aqueous emulsions, the monomers (a) are then polymerized with the aid of the abovementioned free-radical-forming initiators at temperatures of from 0 to 95° C., preferably from 40 to 95° C., and, when using redox systems, at temperatures from 30 to 70° C. If operating under superatmospheric pressure, the emulsion polymerization may also be conducted at temperatures above 100° C. The same applies to the solution polymerization, if relatively high-boiling organic solvents and/or superatmospheric pressure are employed.

It is preferred to commence the initiator feed a certain time, generally from about 1 to 15 minutes, before the monomers are fed in. Preference is given, furthermore, to a process in which the addition of initiator is commenced at the same time as the addition of the monomers and ended about half an hour after the end of the addition of the monomers. The initiator is preferably added in a constant amount per unit time. Following the end of the addition of initiator, the reaction mixture is held at polymerization temperature until (generally from 1 to 1.5 hours) all of the monomers employed have undergone essentially complete reaction. “Essentially complete reaction” is intended to denote that preferably 100% by weight of the monomers employed have undergone reaction but that it is also possible for a small residual monomer content of at most up to about 0.5% by weight, based on the weight of the reaction mixture, to remain unreacted.

Suitable reactors for the graft copolymerization are the customary and known stirred vessels, cascades of stirred vessels, tube reactors, loop reactors or Taylor reactors, as described, for example, in Patent DE 1 071 241 B1, in Patent Applications EP 0 498 583 A1 or DE 198 28 742 A1 or in the article by K. Kataoka in Chemical Engineering Science, volume 50, No. 9, 1995, pages 1409 to 1416.

In accordance with the invention it is of advantage to select the polyurethanes containing thiol groups and the monomers (a) such that the (co)polymer grafted on and/or the grafted hydrophilic polyurethane, but especially the grafted hydrophilic polyurethane, contains hydrophilic functional groups, especially carboxylic acid groups and/or carboxylate groups.

In the graft copolymers of the invention, the proportion of graft base or core to graft shell may exhibit an extremely wide variation, which is a particular advantage of the graft copolymers of the invention.

With the use, preferred in accordance with the invention, of (potentially) anionic hydrophilic functional groups (f2), in particular of carboxylic acid groups, further particular advantages result, since in the graft copolymers of the invention the ratio of acid number of the shell to acid number of the core may likewise be varied in a broad manner.

The graft copolymers of the invention can be isolated from the solutions or dispersions in which they are produced and can be passed on for a very wide variety of end uses, especially in solvent-borne, water- and solvent-free pulverulent solid, or water- and solvent-free liquid coating materials, adhesives and sealing compounds. They are particularly suitable for preparing pigmented or unpigmented, conventional or aqueous coating materials, powder coating materials, powder slurry coating materials or 100% systems.

In accordance with the invention, however, it is of advantage to use the dispersions of the invention, which are produced by the procedure of the invention either as primary dispersions or as secondary dispersions by dispersing the solutions of the graft copolymers of the invention in water, as they are for the preparation of aqueous coating materials, adhesives and sealing compounds of the invention, or as aqueous coating materials, adhesives and sealing compounds. In the coating materials utility, they exhibit outstanding film formation properties.

The aqueous coating materials, adhesives and sealing compounds of the invention may be physically curable, thermally curable, or curable thermally and with actinic radiation.

In the context of the present invention, the term “physical curing” means the curing of a layer of a coating material, of an adhesive or of a sealing compound by the formation of a film as a result of loss of solvent from the coating material, adhesive or sealing compound, linking taking place within the coating by way of formation of loops of the polymer molecules of the binders (regarding the term cf. Römpp Lexikon Lacke und Druckfarben, Georg Thieme Verlag, Stuttgart, New York, 1998, “Binders”, pages 73 and 74). Alternatively, the formation of a film takes place by way of the coalescence of binder particles (cf. Römpp Lexikon Lacke und Druckfarben, Georg Thieme Verlag, Stuttgart, New York, 1998, “Curing”, pages 274 and 275). Normally, no crosslinkers are required for this purpose. If desired, the physical curing can be assisted by atmospheric oxygen, heat, or exposure to actinic radiation.

In the context of the present invention, the term “self-crosslinking” denotes the property of a binder to undergo crosslinking reactions with itself. A precondition for this is that the binder already contains both types of complementary reactive functional groups necessary for crosslinking. Externally crosslinking, on the other hand, is used to denote those coating materials, adhesives and sealing compounds in which one type of the complementary reactive functional groups is present in the binder and the other type in a hardener, curing agent or crosslinker. For further details, refer to Römpp Lexikon Lacke und Druckfarben, Georg Thieme Verlag, Stuttgart, New York, 1998, “Curing”, pages 274 to 276, especially page 275, bottom.

In the context of the present invention, actinic radiation is electromagnetic radiation, such as near infrared (NIR), visible light, UV radiation or X-radiation, especially UV radiation, and corpuscular radiation such as electron beams. If thermal curing and curing with actinic radiation are employed conjointly, the terms “dual cure” and “dual-cure coating material”, “dual-cure adhesive” or “dual-cure sealing compound” are also used.

In addition to the graft copolymers of the invention, the aqueous adhesives of the invention may include further suitable, customary and known constituents in effective amounts. Examples of suitable constituents are the crosslinkers and additives described below, provided they are suitable for the preparation of adhesives.

Likewise, in addition to the graft copolymers of the invention the aqueous sealing compounds of the invention may include further suitable, customary and known constituents in effective amounts. Examples of suitable constituents are, again, the crosslinkers and additives described below, provided they are suitable for preparing sealing compounds.

The inventive primary dispersions and secondary dispersions of the graft copolymers of the invention are primarily suitable for preparing aqueous coating materials, especially aqueous film-forming coating materials. Examples of aqueous film-forming coating materials of the invention are surfacers, solid-color topcoats, aqueous basecoats, and clearcoats. The primary dispersions and secondary dispersions of the invention exhibit very particular advantages when used to prepare aqueous basecoats.

In the aqueous basecoats, the graft copolymers of the invention are advantageously present in an amount of from 1.0 to 50, preferably from 2.0 to 40, with particular preference from 3.0 to 35, with very particular preference from 4.0 to 30, and in particular from 5.0 to 25, % by weight, based in each case on the overall weight of the respective aqueous basecoat.

The further essential constituent of the aqueous basecoat of the invention is at least one color and/or effect pigment. The pigments may consist of organic or inorganic compounds. Because of this large number of suitable pigments, therefore, the aqueous basecoat of the invention ensures universal breadth of use and permits the realization of a large number of color shades and optical effects. Examples of suitable pigments are evident from Römpp Lexikon Lacke und Druckfarben, Georg Thieme Verlag, 1998, page 176 “Effect Pigments”; pages 380 and 381 “Metal Oxide-Mica Pigments” to “Metal Pigments”; pages 180 and 181, “Iron Blue Pigments” to “Iron Oxide Black”; pages 451 to 453, “Pigments” to “Pigment Volume Concentration”; page 563, “Thioinaigo Pigments”; and page 567, “Titanium Dioxide Pigments”.

The aqueous basecoat may comprise at least one crosslinker having the complementary reactive functional groups necessary for thermal crosslinking.

Examples of suitable crosslinkers are amino resins, as described for example in Römpp Lexikon Lacke und Druckfarben, Georg Thieme Verlag, 1998, page 29, “Amino Resins”, in the textbook “Lackadditive” by Johan Bieleman, Wiley-VCH, Weinheim, N.Y., 1998, page 242 ff., in the book “Paints, Coatings and Solvents”, second completely revised edition, Edit. D. Stay and W. Freitag, Wiley-VCH, Weinheim, N.Y., 1998, page 80 ff., in the Patents U.S. Pat. No. 4,710,542 A1 or EP-B-0 245 700 A1, and in the article by B. Singh and co-workers “Carbamylmethylated Melamines, Novel Crosslinkers for the Coatings Industry”, in Advanced Organic Coatings Science and Technology Series, 1991, volume 13, pages 193 to 207; carboxyl-containing compounds or resins, as described for example in the Patent DE 196 52 813 A1, resins or compounds containing epoxide groups, as described for example in Patents EP 0 299 420 A1, DE 22 14 650 B1, DE 27 49 576 B1, U.S. Pat. No. 4,091,048 A1 or U.S. Pat. No. 3,781,379 A1; blocked polyisocyanates, as described for example in Patents U.S. Pat. No. 4,444,954 A1, DE 196 17 086 A1, DE 196 31 269 A1, EP 0 004 571 A1 or EP 0 582 051 A1; and/or tris(alkoxycarbonylamino)triazines, as described in the Patents U.S. Pat. No. 4,939,213 A1, U.S. Pat. No. 5,084,541 A1, U.S. Pat. No. 5,288,865 A1 or EP 0 604 922 A1.

The use of crosslinkers can be omitted if the graft copolymers of the invention that are present in the aqueous basecoats have self-crosslinking properties or crosslink physically.

In addition to the constituents described above, the aqueous basecoat of the invention may include customary and known binders and/or additives in effective amounts.

Examples of customary and known binders are oligomeric and polymeric, thermally curable poly(meth)acrylates or acrylate copolymers which are linear and/or branched and/or of blocklike, comblike and/or random construction, especially the polyesters described in the Patent DE 197 36 535 A1, in particular those described in the Patents DE 40 09 858 A1 or DE 44 37 535 A1, alkyds, acrylated polyesters, polylactones, polycarbonates, polyethers, epoxy resin-amine adducts, (meth)acrylate diols, partially hydrolyzed polyvinyl esters, polyurethanes and acrylated polyurethanes, such as those described in the Patents EP 0 521 928 A1, EP 0 522 420 A1, EP 0 522 419 A1, EP 0 730 613 A1 or DE 44 37 535 A1, or polyureas, or binders curable with actinic radiation, as described for example in German Patent Application DE 198 35 206.9.

Examples of suitable additives are organic and inorganic fillers, thermally curable reactive diluents or reactive diluents curable with actinic radiation (cf. Römpp Lexikon Lacke und Druckfarben, Stuttgart, New York, 1998, page 491), low-boiling organic solvents and/or high-boiling organic solvents (“long solvents”), UV absorbers, light stabilizers, free-radical scavengers, thermally labile free-radical initiators, photoinitiators, crosslinking catalysts, deaerating agents, slip additives, polymerization inhibitors, defoamers, emulsifiers, wetting agents, adhesion promoters, leveling agents, film-forming auxiliaries, rheology control additives, or flame retardants. Further examples of suitable coatings additives are described in the book “Lackadditive” by Johan Bieleman, Wiley-VCH, Weinheim, N.Y,, 1998.

The preparation of the aqueous basecoat of the invention has no special features but instead takes place in a customary and known manner by mixing the constituents described above in suitable mixing equipment such as stirred vessels, dissolvers, stirred mills, static mixers, toothed-wheel dispersers or extruders by the processes suitable for preparing the respective aqueous basecoats.

Of course, the above-described pigments, crosslinkers and other additives, and also the above-described methods, can also be employed to prepare the adhesives and sealing compounds of the invention.

The aqueous basecoat is outstandingly suitable for the production of color and/or effect multicoat finishes by the wet-on-wet process, in which an aqueous basecoat film is applied, dried and overcoated with a clearcoat film, after which aqueous basecoat film and clearcoat film are cured together. As is known, this process is used with advantage in the OEM finishing and refinishing of motor vehicles.

Owing to their particularly advantageous properties, however, the coating materials of the invention are, moreover, also suitable for the coating of interior and exterior architectures, for the painting of furniture, windows or doors, and industrial coating, including coil coating, container coating, and the impregnation or coating of electrical components. In the context of the industrial coatings, they are suitable for coating virtually all parts for private or industrial use, such as radiators, domestic appliances, small metal parts such as screws and nuts, wheel caps, rims, packaging, or electrical components such as motor windings or transformer windings.

The adhesives and sealing compounds of the invention are outstandingly suitable for the production of adhesive films and seals which even under extreme and/or rapidly changing climatic conditions, persistently, are of particularly high bond strength and sealing power.

Accordingly, the primed or unprimed substrates commonly employed in the abovementioned technological fields, and coated with at least one coating of the invention, bonded with at least one adhesive film of the invention, and/or sealed with at least one seal of the invention, combine a particularly advantageous profile of performance properties with a particularly long service life, which makes them particularly attractive from an economic standpoint.

### EXAMPLES

### Preparation Example 1

### The Preparation of a Polyester Polyol

In a unit suitable for polyester synthesis, 891.2 parts by weight of Pripol® 1013 (commercial dimeric fatty acid), 292.8 parts by weight of 1,6-hexanediol, 360.3 parts by weight of isophthalic acid and 250.7 parts by weight of neopentyl glycol, with xylene as entrainer, were reacted until the acid number was <5 mg KOH/g. The xylene was subsequently removed by distillation and the polyester was allowed to react further until the acid number was from 3 to 4 mg KOH/g. The polyester was cooled to 110° C. and diluted with methyl ethyl ketone to a solids content of 73% by weight (theoretical). The number-average molecular weight was 2333 daltons, the mass-average molecular weight 4912 daltons.

### Preparation Example 2

### The Preparation of a Polyurethane Containing Thiol Groups

In an apparatus suitable for reacting isocyanates, 1535.1 parts by weight of the polyester solution as in Preparation Example 1, 160 parts by weight of dimethylolpropionic acid, 16 parts by weight of neopentyl glycol and 636 parts by weight of tetramethylxylylidene diisocyanate were reacted with one another at 90° C. until the isocyanate content was constant. The resulting polyurethane prepolymer solution was diluted with 413.9 parts by weight of methyl ethyl ketone to a solids content of 70% by weight (theoretical).

The polyurethane prepolymer was reacted in solution at 90° C. with 14.4 parts by weight of mercaptoethanol to give a polyurethane solution having a solids content of 70.4% by weight (theoretical).

### Preparation Example 3

### The Preparation of an Aqueous Dispersion of the Polyurethane of Preparation Example 2

66.2 parts by weight of the polyurethane solution of Preparation Example 2 were neutralized with 14.4 parts by weight of triethylamine. The resulting solution was dispersed in 920.1 parts by weight of water at 82° C.

### Example 1

### The Preparation of a Primary Dispersion of the Invention

A customary and known polymerization vessel equipped with stirrer, reflux condenser and two feed vessels was charged with 1606.7 parts by weight of the dispersion of Preparation Example 3. Metered in to this initial charge over 4 hours via the first feed vessel was a monomer mixture comprising 80 parts by weight of hydroxypropyl methacrylate, 23 parts by weight of n-butyl acrylate, 46 parts by weight of styrene, 46 parts by weight of tert-butylcyclohexyl acrylate and 34.5 parts by weight of methyl methacrylate, 11.5 parts by weight of tert-butyl per-2-ethylhexanoate were metered in via the second feed vessel over 4.5 hours, and the mixture was polymerized at 82° C. Monomer feed and initiator feed were commenced simultaneously. After the end of the initiator feed, polymerization was continued for 1 hour. The resulting primary dispersion was diluted with 383.2 parts by weight of water. Its solids content (1 hour/130° C.) was 31.40% by weight, its acid number 25.8 mg KOH/g and its pH 7.9. The dispersion was poured onto glass, and after drying and physical curing gave glass-clear coatings. Furthermore, it was outstandingly suitable for the preparation of aqueous basecoats.

### Example 2

### The Preparation of a Secondary Dispersion of the Invention

461 parts by weight of the polyurethane solution of Preparation Example 2 were charged to the polymerization vessel described above, and diluted with 110 parts by weight of methyl isobutyl ketone and heated to 110° C. Over 4 hours, a monomer mixture comprising 54 parts by weight of hydroxypropyl methacrylate, 15 parts by weight of n-butyl acrylate, 31 parts by weight of styrene, 31 parts by weight of tert-butylcyclohexyl acrylate and 23 parts by weight of methyl methacrylate was metered in to this initial charge via the first feed vessel, and, over the course of 4.5 hours, 11.5 parts by weight of tert-butyl per-2-ethylhexanoate in 15 parts by weight of methyl isobutyl ketone were metered in via the second feed vessel, and the mixture was polymerized at 110° C. Monomer and initiator feed were commenced simultaneously. After the end of the initiator feed, polymerization was continued for 1 hour. The resulting solution of the graft copolymer was neutralized with 25.8 parts by weight of triethylamine.

431.8 parts by weight of the graft copolymer solution were mixed at 80° C first with 282.2 and then with 428.8 parts by weight of water, after which the resulting mixture was finely dispersed. The resulting secondary dispersion had a solids content (1 hour/130° C.) of 23% by weight, an acid number of 32.7 mg KOH/g and a pH of 8.5. It was highly suitable for the preparation of aqueous basecoats or of aqueous adhesives and sealing compounds.

Graft copolymers based on polyurethane, the production thereof and their use

1. A graft copolymer based on polyurethane, preparable by graft copolymerizing at least one hydrophobic or hydrophilic polyurethane containing on average at least one thiol group with at least one olefinically unsaturated monomer in solution or in an aqueous dispersion.

2. An aqueous dispersion comprising at least one graft copolymer based on polyurethane, preparable by graft copolymerizing at least one hydrophobic or hydrophilic polyurethane containing on average at least one thiol group with at least one olefinically unsaturated monomer in an aqueous dispersion or by graft copolymerizing at least one hydrophobic or hydrophilic polyurethane containing on average at least one thiol group with at least one olefinically unsaturated monomer in solution and then dispersing the solution in an aqueous medium.

3. A coating material, adhesive or sealing compound comprising at least one graft copolymer based on polyurethane preparable by graft copolymerizing at least one hydrophobic or hydrophilic polyurethane containing on average at least one thiol group with at least one olefinically unsaturated monomer in solution or in an aqueous dispersion, or comprising an aqueous dispersion of said graft copolymer.

4. A process for preparing a graft copolymer based on polyurethane by graft copolymerizing at least one hydrophilic or hydrophobic polyurethane with at least one olefinically unsaturated monomer in solution or in an aqueous dispersion, which comprises using at least one polyurethane containing on average at least one thiol group.

5. A graft copolymer as claimed in claim 1, dispersion as claimed in claim 2, coating material, adhesive or sealing compound as claimed in claim 3, or process as claimed in claim 4, wherein said polyurethane contains at least two thiol groups.

6. A graft copolymer as claimed in claim 1 or 5, dispersion as claimed in claim 2 or 5, coating material, adhesive or sealing compound as claimed in claim 3 or 5, or process as claimed in claim 4 or 5, wherein said polyurethane is preparable by reacting at least one polyurethane prepolymer having at least one free isocyanate group with at least one polythiol and/or at least one compound having at least one thiol group and at least one hydroxyl group.

7. A graft copolymer as claimed in any of claims 1, 5 or 5, dispersion as claimed in any of claims 2, 5 or 6, coating material, adhesive or sealing compound as claimed in any of claims 3, 5 or 6, or process as claimed in any of claims 4 to 6, wherein the hydrophilic polyurethane contains alternatively
(f1) functional groups which can be converted into cations by neutralizing agents and/or quaternizing agents, and/or cationic groups, especially ammonium groups, or
(f2) functional groups which can be converted into anions by neutralizing agents, and/or anionic groups, especially carboxylic acid and/or carboxylate groups, and/or
(f3) nonionic hydrophilic groups, especially poly(alkylene ether) groups.

8. A coating material, adhesive or sealing compound as claimed in any of claims 3 or 5 to 7, which is physically curable, thermally curable, or curable thermally and with actinic radiation.

9. A coating, adhesive film or sealing compound preparable with the aid of a coating material, adhesive or sealing compound as claimed in any of claims 3 or 5 to 8.
